(19) United States
(12) Patent Application Publication
(10) Pub. No.: US 2026/0269507 A1
(43) Pub. Date: Sep. 10, 2026

(54) CONNECTOR AND CONNECTOR ASSEMBLY

(71) Applicant: Xuancheng Luxshare Precision Industry Co.,Ltd, Xuancheng City (CN)

(72) Inventors: Ankang SHENG, Xuancheng City (CN); Weihe HONG, Xuancheng City (CN); Haomai YIN, Xuancheng City (CN)

(73) Assignee: Xuancheng Luxshare Precision Industry Co.,Ltd, Xuancheng City (CN)

(21) Appl. No.: 19/367,558

(22) Filed: Oct. 23, 2025

(30) Foreign Application Priority Data
Mar. 10, 2025 (CN) 202510275714.1

(51) Int. Cl. H01R 13/434; H01R 13/52

(52) U.S. Cl. CPC H01R 13/434; H01R 13/521; H01R 2201/04

(57) ABSTRACT

Provided are a connector and a connector assembly, relating to the field of connector technology. The connector includes an insulating body, a first terminal, and a first locking member. The insulating body is provided with a first mounting hole. A first fastener is disposed in the first mounting hole. The first terminal is inserted into the first mounting hole and snap-fitted to the first fastener. The first locking member is detachably inserted into the insulating body and configured to allow the first terminal to be inserted into the first mounting hole when the first locking member is at the pre-installation position of the first locking member and limit the position of the first fastener when the first locking member is at the final locking position of the first locking member so that the first fastener is kept snap-fitted to the first terminal.

### CROSS-REFERENCE TO RELATED APPLICATION

The present application claims priority to Chinese Patent Application No. 202510275714.1, filed with the China National Intellectual Property Administration (CNIPA) on March 10, 2025, the disclosure of which is incorporated herein by reference in its entirety.

### TECHNICAL FIELD

This invention relates to the field of connector technology, particularly a connector and a connector assembly.

### BACKGROUND

A connector assembly is a device that connects two active components and is used for transmitting current or signals. A connector assembly includes a connector and a mating connector that mate with each other. With an increasing demand for communication between electronic devices, the need for connections and wiring between electronic devices is also growing. To reduce the space cost of connector assemblies used for connections between electronic devices and improve the connection efficiency, the number of terminals in connectors is also increasing.

Terminals are usually inserted into mounting holes formed on the insulating body. To ensure that each terminal can be reliably locked to the insulating body of the connector, each terminal has a snap portion for being locked and secured to the insulating body.

However, in complex transportation or application environments, a connector may be subjected to sudden conditions such as mechanical vibrations, impacts, and temperature changes. These conditions may cause the snap portion to detach from the insulating body, making the terminal disengaged from the insulating body, thus affecting the assembly stability of the connector and the signal connection stability between the connector and the mating connector.

### SUMMARY

An object of this invention is to provide a connector and a connector assembly, solving the problem of unstable performance of the connector and the connector assembly caused by poor assembly stability between a terminal and an insulating body.

To achieve this object, this invention uses the following solutions.

A connector includes an insulating body, a first terminal, and a first locking member. The insulating body is provided with a first mounting hole. A first fastener is disposed in the first mounting hole. The first terminal is inserted into the first mounting hole and snap-fitted to the first fastener. The first locking member is detachably inserted into the insulating body and configured to allow the first terminal to be inserted into the first mounting hole when the first locking member is at the pre-installation position of the first locking member and limit the position of the first fastener when the first locking member is at the final locking position of the first locking member so that the first fastener is kept snap-fitted to the first terminal.

Optionally, the first locking member is inserted into the insulating body along the length direction of the first mounting hole.

Optionally, the first locking member includes a sleeve portion and an insertion portion. The sleeve portion is connected to the insertion portion and located outside the insertion portion. The sleeve portion is sleeved around the insulating body. An inner side of the insertion portion abuts against the side of the first fastener facing away from the first terminal when the first locking member is at the final locking position.

Optionally, a first positioning block is disposed on one of the first locking member or the insulating body, a first slot hole snap-fitted to the first positioning block is formed on the other of the first locking member or the insulating body, two first slot holes are provided, and the first positioning block is snap-fitted to one of the two first slot holes when the first positioning block is at the pre-installation position of the first locking member and is snap-fitted to the other of the two first slot holes when the first positioning block is at the final locking position of the first locking member.

Optionally, the connector also includes a second terminal, the insulating body is provided with a second mounting hole, and the second terminal is inserted into the second mounting hole.

Optionally, the connector also includes a first sealing ring secured to one side of the insulating body and abutting against the insulating body. Multiple second terminals are provided. Multiple second mounting holes are provided. The second terminals are in one-to-one correspondence with the second mounting holes. Each second terminal is connected to a second cable that passes through the first sealing ring.

Optionally, the first terminal is a low-voltage terminal, and the second terminal is a terminal for transmitting an Ethernet signal.

Optionally, the connector also includes a second sealing ring sleeved around the insulating body and configured to abut against a mating connector sleeved around the insulating body.

Optionally, the connector also includes a housing fixedly sleeved around the insulating body.

Optionally, a gap for the mating connector to be inserted into is formed between the housing and the insulating body, and the connector also includes a third locking member inserted into the housing and configured to lock the mating connector.

A connector assembly includes the preceding connector and a mating connector for mating with the connector.

The beneficial effects of this invention: The connector and the connector assembly of this invention use the first locking member in cooperation with the first fastener to lock the first terminal, improving the stability of the first terminal assembled on the insulating body and keeping the performance of the connector and the connector assembly stable.

### BRIEF DESCRIPTION OF DRAWINGS

FIG. 1 is a structure view of a connector taken from one angle according to an embodiment of this invention.

FIG. 2 is a structure view of a connector taken from another angle according to an embodiment of this invention.

FIG. 3 is an exploded structure view of a connector according to an embodiment of this invention.

FIG. 4 is a side view of a connector according to an embodiment of this invention.

FIG. 5 is a section view taken along A-A of FIG. 4.

FIG. 6 is a section view taken along B-B of FIG. 4 when a first locking member is at the pre-installation position.

FIG. 7 is a section view taken along B-B of FIG. 4 when a first locking member is at the final locking position.

FIG. 8 is a section view taken along C-C of FIG. 4.

FIG. 9 is a rear view of a connector without housing.

FIG. 10 is a section view taken along D-D of FIG. 9 when a second locking member is at the pre-installation position.

FIG. 11 is a section view taken along D-D of FIG. 9 when a second locking member is at the final locking position.

FIG. 12 is a structure view of an insulating body taken from one angle according to an embodiment of this invention.

FIG. 13 is a view of an insulating body taken from another angle according to an embodiment of this invention.

FIG. 14 is a structure view of a first locking member according to an embodiment of this invention.

FIG. 15 is a structure view of a first terminal according to an embodiment of this invention.

FIG. 16 is a structure view of a second locking member according to an embodiment of this invention.

FIG. 17 is a structure view of a second terminal according to an embodiment of this invention.

FIG. 18 is a rear view of a connector with a housing according to an embodiment of this invention.

FIG. 19 is a section view taken along E-E of FIG. 18 when a third locking member is at the pre-installation position.

FIG. 20 is a section view taken along E-E of FIG. 18 when a third locking member is at the final locking position.

FIG. 21 is a structure view of a third locking member according to an embodiment of this invention.

FIG. 22 is a structure view of a housing taken from one angle according to an embodiment of this invention.

FIG. 23 is a structure view of a housing taken from another angle according to an embodiment of this invention.

FIG. 24 is a structure view of a first sealing ring according to an embodiment of this invention.

FIG. 25 is a structure view of a second sealing ring according to an embodiment of this invention.

### DETAILED DESCRIPTION

This invention is further described in detail hereinafter in conjunction with drawings and embodiments. It is to be understood that the embodiments described herein are intended to explain this invention and not to limit this invention. Additionally, it is to be noted that for ease of description, part, not all, of the structures related to this invention are illustrated in the drawings.

In the description of this invention, unless otherwise expressly specified and limited, the term "connected to each other", "connected", or "secured" is to be construed in a broad sense, for example, as securely connected, detachably connected, or integrated; mechanically connected or electrically connected; directly connected to each other or indirectly connected to each other via an intermediary; or internally connected or interactional between two components. For those of ordinary skill in the art, meanings of the preceding terms in this invention may be understood based on situations.

In this invention, unless otherwise expressly specified and limited, when a first feature is described as "above" or "below" a second feature, the first feature and the second feature may be in direct contact or be in contact via another feature between the two features. Moreover, when the first feature is described as "on", "above", or "over" the second feature, the first feature is right on, above, or over the second feature, the first feature is obliquely on, above, or over the second feature, or the first feature is simply at a higher level than the second feature. When the first feature is described as "under", "below", or "underneath" the second feature, the first feature is right under, below, or underneath the second feature, the first feature is obliquely under, below, or underneath the second feature, or the first feature is simply at a lower level than the second feature.

In the description of this embodiment, the orientation or position relationships indicated by terms such as "above", "below", "left" and "right" are based on the orientation or position relationships shown in the drawings. These orientations or position relationships are only for ease of description and simplifying an operation and do not indicate or imply that the referred device or element must have a specific orientation and is constructed and operated in a specific orientation. Thus, these orientations or position relationships are not to be construed as limiting this invention. In addition, the terms "first" and "second" are used only for distinguishing between descriptions and have no special meaning.

An embodiment of this invention provides a connector assembly. The connector assembly includes a connector and a mating connector (not shown) that can mate with the connector. It is to be understood that one of the connector or the mating connector is disposed on the device body of a device, for example, an in-vehicle processing device such as a domain controller or an in-vehicle infotainment (IVI), and the other of the connector or the mating connector is connected by a cable to another device, for example, an in-vehicle device such as a laser radar or a gateway. The following describes the structure of the connector in detail by using an example in which a cable is disposed on the connector:

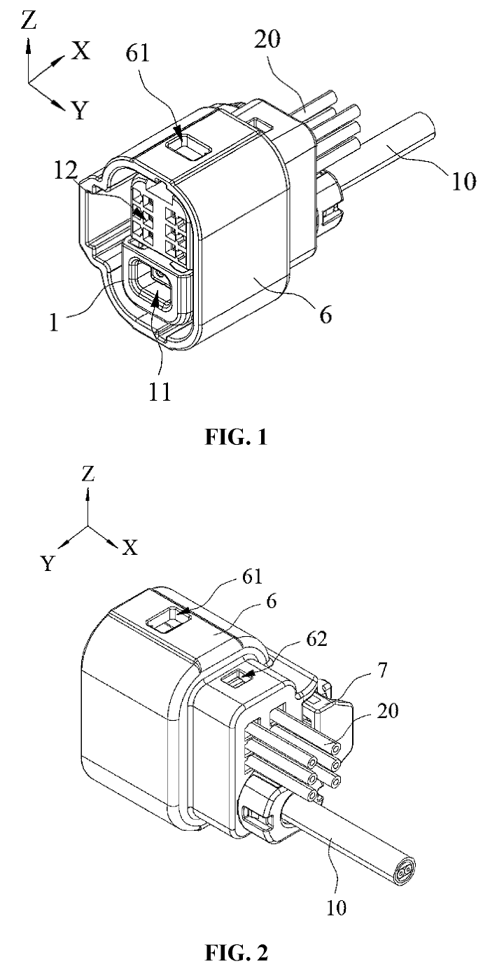

Referring to FIG. 1 to FIG. 3, the connector includes an insulating body 1, a first terminal 2, and a first locking member 4. The insulating body 1 is provided with a first mounting hole 11. The first terminal 2 is inserted into the first mounting hole 11. A first fastener 13 is disposed in the first mounting hole 11. The first fastener 13 is snap-fitted to the first terminal 2 to lock the first terminal 2 to the preset position of the first mounting hole 11. The first locking member 4 is detachably inserted into the insulating body 1 and configured to allow the first terminal 2 to be inserted into the first mounting hole 11 when the first locking member 4 is at the pre-installation position of the first locking member 4 and limit the position of the first fastener 13 when the first locking member 4 is at the final locking position of the first locking member 4 so that the first fastener 13 is kept snap-fitted to the first terminal 2.

The connector and the connector assembly lock the first terminal 2 by using the first fastener 13 and then limit the position of the first fastener 13 by using the first locking member 4 so that the first fastener 13 keeps locking the first terminal 2, improving the connection stability between the first terminal 2 and the insulating body 1 and thus facilitating maintaining the performance of the connector and the connector assembly.

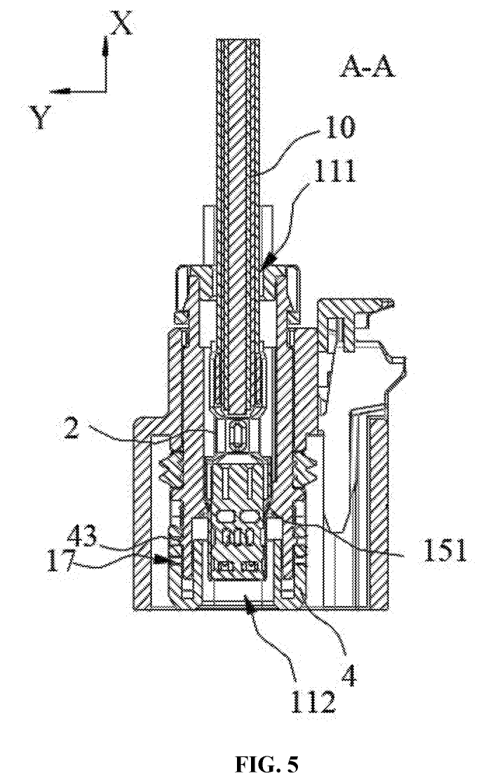

Referring to FIG. 5 to FIG. 7, the first mounting hole 11 has a first hole opening 111 and a second hole opening 112 opposite to each other in a first direction. The first hole opening 111 is disposed on a forward side of the second hole opening 112 in the first direction. The first terminal 2 can be inserted into the first mounting hole 11 from the first hole opening 111 and moved toward the second hole opening 112. A first mating terminal adapted to the first terminal 2 and located on the mating connector can be electrically connected to the first terminal 2 through the second hole opening 112. A first stop surface 151 is formed on the side of the inner wall of the first mounting hole 11 adjacent to the second hole opening 112. The first stop surface 151 can abut against the first abutting surface 211 on the first terminal 2, limiting the first terminal 2 from continuing moving toward the second hole opening 112, so that the first terminal 2 is inserted into the preset position of the first mounting hole 11.

Referring to FIG. 5 and FIG. 12, two first stop blocks 15 are oppositely disposed on the inner wall surface of the first mounting hole 11 along a second direction (a direction Y and the reverse direction of the direction Y in FIG. 1, where the direction Y is the forward direction of the second direction, and the reverse direction of the direction Y is the reverse direction of the second direction). The first stop surface 151 is formed on the inner side surface of the first stop block 15 and is disposed gradually away from the hole wall of the first mounting hole 11 from the end of first stop surface 151 facing the first hole opening 111 to the end of first stop surface 151 facing away from the first hole opening 111. Correspondingly, the first abutting surface 211 is also inclined. The second direction is perpendicular to the first direction.

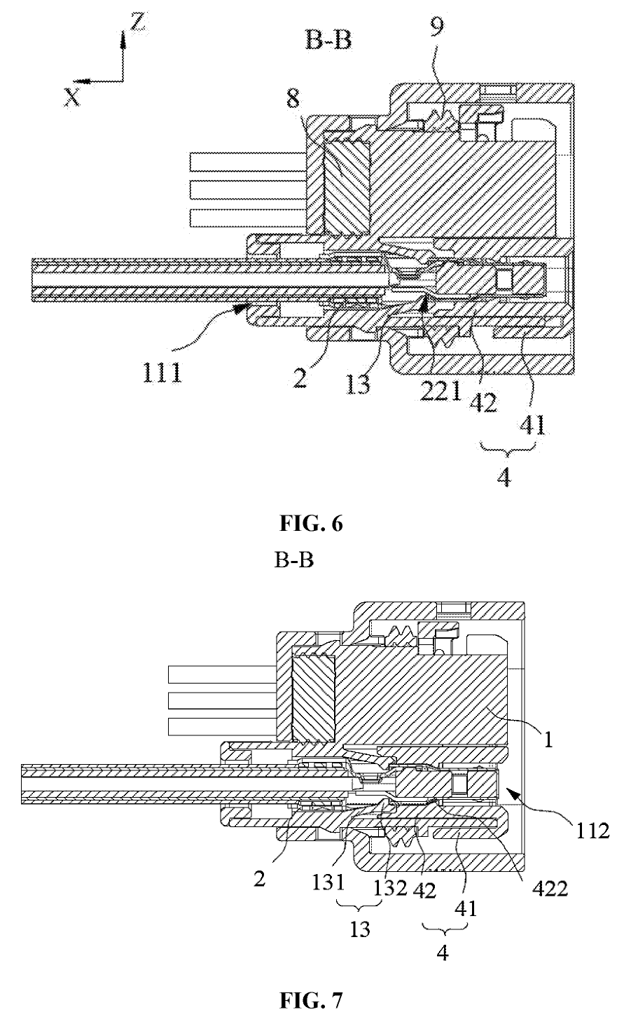

Referring to FIG. 6 and FIG. 7, the outer wall surface of the first terminal 2 is provided with a first recess 221, and the first fastener 13 includes a first elastic arm 131 and a first locking block 132 that are integrally formed. The end of the first elastic arm 131 facing the first hole opening 111 is connected to the hole wall of the first mounting hole 11. The other end of the first elastic arm 131 is gradually away from the hole wall of the first mounting hole 11 in the direction toward the second hole opening 112. The first locking block 132 is disposed on the side of the first elastic arm 131 facing away from the hole wall of the first mounting hole 11.

The first terminal 2 can press the first fastener 13 after being inserted into the first mounting hole 11 from the first hole opening 111. The first elastic arm 131 deforms to drive the first locking block 132 to move toward the hole wall of the first mounting hole 11 until the first locking block 132 is locked into the first recess 221. At this time, the first stop surface 151 abuts against the first abutting surface 211. The first fastener 13 locks the first terminal 2 to prevent the first terminal 2 from moving toward the first hole opening 111.

Specifically, two first fasteners 13 are symmetrically disposed in the first mounting hole 11 along a third direction (a direction Z and the reverse direction of the direction Z in FIG. 1, where the direction Z is the forward direction of the third direction, and the reverse direction of the direction Z is the reverse direction of the third direction) to improve the stability of locking the first terminal 2 by the first fasteners 13. More specifically, the two first fasteners 13 are disposed, in a one-to-one manner, in two gaps formed by the two first stop blocks 15 and connected to the first stop blocks 15 to improve the structural strength of the first fasteners 13. The third direction is perpendicular to the first direction and the second direction.

More specifically, the side of the first locking block 132 facing the first hole opening 111 is provided with a first guide surface. The first guide surface is gradually away from the hole wall of the first mounting hole 11 from the side of the first guide surface facing the first hole opening 111 to the side of the first guide surface facing away from the first hole opening 111 to reduce the difficulty of crossing the first locking block 132 when the end of the first terminal 2 inserted into the first mounting hole 11 moves toward the second hole opening 112.

In this embodiment, to reduce the difficulty of inserting the first terminal 2 into the first mounting hole 11, the area of the first hole opening 111 is greater than the maximum cross-sectional area of the first terminal 2. On this basis, the connector also includes an end cover 30. The end cover 30 is mounted on the insulating body 1 and located on the side of the first hole opening 111 of the first mounting hole 11. The end cover 30 is provided with a threading hole through which a first cable 10 connected to the first terminal 2 can pass. The area of the threading hole is smaller than the area of the first hole opening 111.

After the first terminal 2 connected to the first cable 10 is inserted into the first mounting hole 11, the end cover 30 is mounted on the insulating body 1, reducing the possibility of shaking of the first cable 10 and improving the stability of the connector. Specifically, the end cover 30 is snap-fitted to the insulating body 1 to facilitate the maintenance and replacement of the first terminal 2.

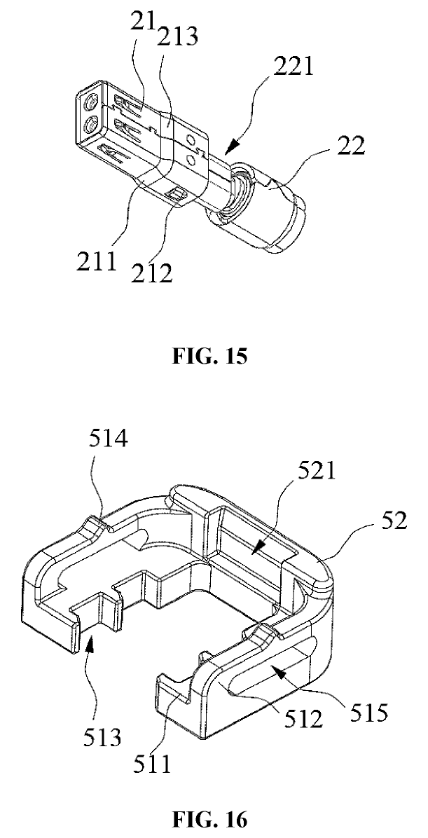

Referring to FIG. 15, the first terminal 2 includes a front shielding shell 21, an inner conductor, a wire clamp, and a rear shielding shell 22. The rear end of the front shielding shell 21 is sleeved on the rear shielding shell 22 and crimped with the rear shielding shell 22. The inner conductor is located in the front shielding shell 21 and can be used to electrically connect the first mating terminal and the cable. The wire clamp is located in the rear shielding shell 22 and can be used to secure one end of the cable in the rear shielding shell 22. The front shielding shell 21 is provided with a small-diameter section and a large-diameter section in sequence in the reverse direction of the first direction. The first abutting surface 211 is formed between the large-diameter section and the small-diameter section. The rear shielding shell 22 is in the shape of a dumbbell. The first recess 221 is an annular groove formed on the rear shielding shell 22. The annular groove is located outside the front shielding shell 21.

It is to be understood that in other embodiments, the first recess 221 may be disposed on the first elastic arm 131, and the first locking block 132 is disposed on the first terminal 2.

Referring to FIG. 12 and FIG. 15, to prevent the first terminal 2 from being inserted into the first mounting hole 11 too far and causing damage to the first terminal 2 or the insulating body 1, in this embodiment, the inner side surface of the first stop block 15 is also provided with a guide groove 152 extending in the first direction. The side of the guide groove 152 facing the second hole opening 112 is closed. A guide block 212 slidably fitting the guide groove 152 is disposed on the outer wall surface of the first terminal 2. When the first terminal 2 is in the preset position in the first mounting hole 11, the guide block 212 abuts against the groove wall at the end of the guide groove 152 facing the second hole opening 112. Specifically, the guide block 212 is disposed on the outer wall surface of the large-diameter section.

The first locking member 4 is inserted into the first mounting hole 11 along the length direction of the first mounting hole 11, that is, along the first direction. Referring to FIG. 14, the first locking member 4 includes a sleeve portion 41 and an insertion portion 42. The sleeve portion 41 is connected to the insertion portion 42 and located outside the insertion portion 42. A clamping space having an opening facing the first hole opening 111 is formed between the sleeve portion 41 and the insertion portion 42. The insertion portion 42 is inserted into the first mounting hole 11 from the second hole opening 112. The sleeve portion 41 is sleeved around the insulating body 1. In this manner, the insulating body 1 is clamped in the clamping space.

The first locking member 4 is inserted into the first mounting hole 11 from the second hole opening 112. Referring to FIG. 6 and FIG. 7, when the first locking member 4 is at the pre-installation position, the first locking member 4 and the first fastener 13 are spaced apart in the first direction, and the first locking member 4 does not interfere with the deformation of the first fastener 13 so that the first terminal 2 can be inserted into the preset position of the first mounting hole 11 from the first hole opening 111; and when the first locking member 4 is at the final locking position, the first fastener 13 moves toward the first terminal 2 along the first direction, the inner side of the insertion portion 42 abuts against the side of the first fastener 13 facing away from the first terminal 2, and limited by the insertion portion 42, the first fastener 13 is no longer capable of deforming toward the hole wall of the first mounting hole 11 and thus keeps snap-fitted to the first terminal 2, thereby maintaining the stability of the first terminal 2 inserted into the first mounting hole 11. It is to be noted that when the first locking member 4 is at the final locking position, the end surface of the insulating body 1 abuts against the side of the clamping space facing away from the opening, limiting the first locking member 4 from continuing moving toward the first hole opening 111.

Specifically, a step surface 421 is formed at the end of the insertion portion 42 inserted into the first mounting hole 11. When the first locking member 4 is at the final locking position, the first fastener 13 abuts against the step surface 421 to determine the final locking position of the first locking member 4, better reducing the possibility that the first locking member 4 is excessively inserted into the first mounting hole 11.

Moreover, a second stop surface 422 is formed on the side of the first locking member 4 facing the first terminal 2. The second stop surface 422 is gradually away from the hole wall of the first mounting hole 11 from the end of the second stop surface 422 facing the first hole opening 111 to the end of the second stop surface 422 facing away from the first hole opening 111. A second abutting surface 213 fitting the second stop surface 422 is formed on the outer wall surface of the first terminal 2. When the first locking member 4 is at the final locking position, the second stop surface 422 abuts against the second abutting surface 213 and cooperates with the first stop surface 151 and the first abutting surface 211 to better prevent the first terminal 2 from moving toward the second hole opening 112.

More specifically, two opposite second stop surfaces 422 are formed on the inner side wall of the first locking member 4. Correspondingly, two second abutting surfaces 213 are formed. The two second abutting surfaces 213 are also formed between the small-diameter section and the large-diameter section of the front shielding shell 21. That is, the second abutting surface 213 and the first abutting surface 211 form a conical surface connecting the large-diameter section and the small-diameter section.

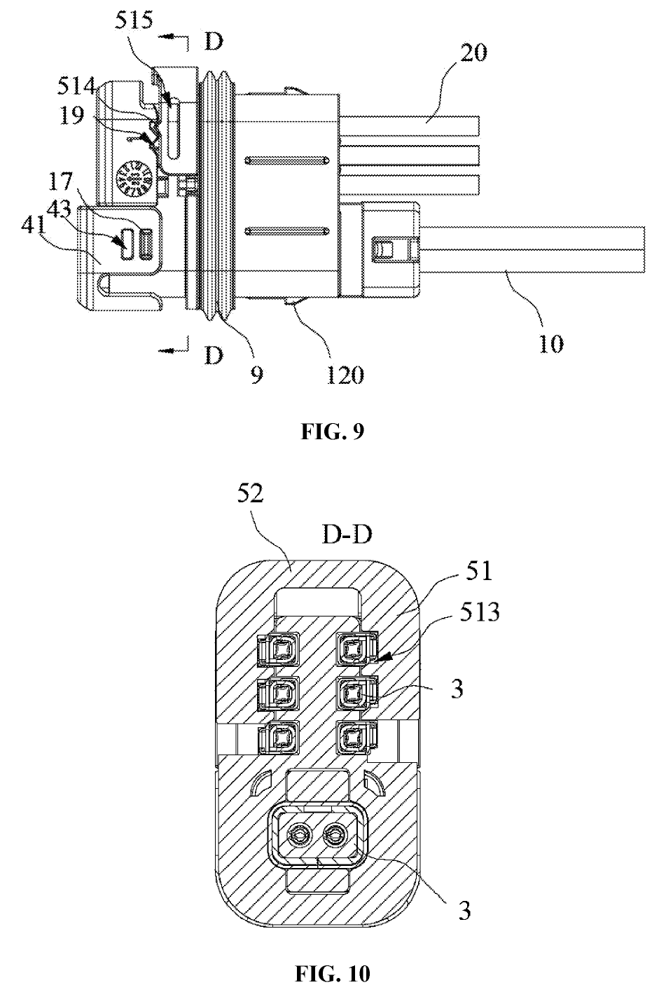

Referring to FIG. 5 and FIG. 9, to facilitate the observation of whether the first locking member 4 is at the pre-installation position or the final locking position and improve the stability of the first locking member 4 assembled on the insulating body 1, a first positioning block 17 is also disposed on one of the first locking member 4 or the insulating body 1, and a first slot hole 43 snap-fitted to the first positioning block 17 is formed the other of the first locking member 4 or the insulating body 1. Two first slot holes 43 are provided and spaced apart in the first direction. When the first positioning block 17 is limited in one of the two first slot holes 43 far from the second hole opening 112, the first locking member 4 is at the pre-installation position. When the first positioning block 17 is limited in one of the two first slot holes 43 adjacent to the second hole opening 112, the first locking member 4 is at the final locking position.

Illustratively, the first positioning block 17 is disposed on the insulating body 1, and the first slot 43 is disposed on the first locking member 4. Specifically, the cross section of the first positioning block 17 is configured as an equilateral trapezoid or an equilateral triangle with chamfered corners to reduce the difficulty of the first positioning block 17 entering and leaving the first slot hole 43.

Referring to FIG. 14, to reduce the difficulty of disengaging the first locking member 4 from the insulating body 1, an avoidance notch 411 is formed in the sleeve portion 41, and the avoidance notch 411 extends along the first direction to the end surface of the sleeve portion 41 facing the first terminal 2. When the first locking member 4 is disassembled by using a force applied to the sleeve portion 41 in a direction away from the insulating body 1 in the second direction, the first positioning block 17 can be separated from the first slot hole 43.

The connector also includes a second terminal 3 and a second locking member 5. The insulating body 1 is provided with a second mounting hole 12. The second terminal 3 is inserted into the second mounting hole 12. A second fastener 14 is disposed in the second mounting hole 12. The second fastener 14 is configured to lock the second terminal 3 to the preset position of the second mounting hole 12. The second locking member 5 is detachably inserted into the insulating body 1. The second locking member 5 also has a pre-installation position and a final locking position. The second locking member 5 allows the second terminal 3 to be inserted into the second mounting hole 12 when the second locking member 5 is at the pre-installation position and can lock the second terminal 3 when the second locking member 5 is at the final locking position.

In this embodiment, the first terminal 2 and the second terminal 3 are connected to the first cable 10 and a second cable 20 respectively, and the first terminal 2 and the second terminal 3 have different functions. For example, if the first terminal 2 is a signal terminal for transmitting an Ethernet signal, then the first cable 10 connected to the first terminal 2 is a high-speed signal cable, and if the second terminal 3 is a low-voltage terminal for transmitting a low-speed CAN signal, then the second cable 20 connected to the second terminal 3 is a low-voltage cable. To adapt to the first terminal 2 and the second terminal 3, the first mounting hole 11 and the second mounting hole 12 have different internal spaces, and the internal space of the first mounting hole 11 is larger than the internal space of the second mounting hole 12.

Specifically, referring to FIG. 1 and FIG. 2, the second mounting hole 12 also extends in the first direction (a direction X and the reverse direction of the direction X in FIG. 1, where the direction X is the forward direction of the first direction, and the reverse direction of the direction X is the reverse direction of the first direction), and the first mounting hole 11 and the second mounting hole 12 are spaced apart in the third direction. Due to the limited internal space of the second mounting hole 12, to reduce the difficulty of assembling the second locking member 5 on the insulating body 1, the second locking member 5 moves in the third direction to switch between the pre-installation position and the final locking position.

The number of first mounting holes 11 and the number of second mounting holes 12 are not limited in this embodiment of this application. Illustratively, the number of first mounting holes 11 is 1, and the number of second mounting holes 12 is 6. The six second mounting holes 12 are disposed in two rows symmetrical along the second direction (the direction Y and the reverse direction of the direction Y in FIG. 1, where the direction Y is the forward direction of the second direction, and the reverse direction of the direction Y is the reverse direction of the second direction). Any row of the second mounting holes 12 includes three second mounting holes 12 spaced apart along the third direction. The number of second terminals 3 is the same as the number of second mounting holes 12. The number of second terminals 3 is also 6. In this case, the second locking member 5 moving in the third direction can lock multiple second terminals 3 simultaneously. The second direction is perpendicular to the first direction and the third direction.

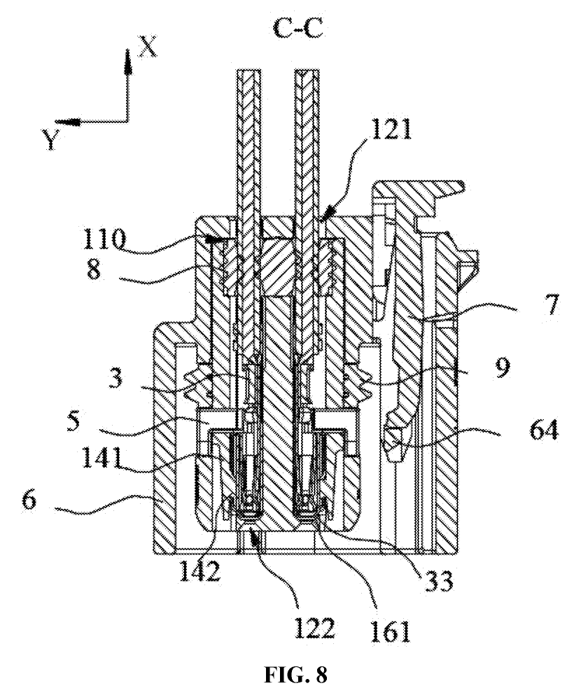

Referring to FIG. 8, the second mounting hole 12 has a third hole opening 121 and a fourth hole opening 122 oppositely disposed in the first direction. The third hole opening 121 and the first hole opening 111 are located on the same side of the insulating body 1. A third stop surface 161 is formed on the side of the second mounting hole 12 facing the fourth hole opening 122. The third stop surface 161 can abut against the third abutting surface 33 on the second terminal 3, preventing the second terminal 3 from continuing moving toward the fourth hole opening 122 so that the second terminal 3 can be inserted into the preset position of the second mounting hole 12.

Specifically, an annular second stop block 16 is disposed on the side of the second mounting hole 12 facing the fourth hole opening 122, the third stop surface 161 is formed on the side of the second stop block 16 facing away from the fourth hole opening 122 and is configured as a tapered surface, the third stop surface 161 gradually expands from the end of the third stop surface 161 facing the fourth hole opening 122 to the end of the third stop surface 161 facing away from the fourth hole opening 122, a tapered third abutting surface 33 is formed on the outer wall surface of the second terminal 3, and when the third abutting surface 33 abuts against the third stop surface 161, the second terminal 3 is inserted into the preset position of the second mounting hole 12.

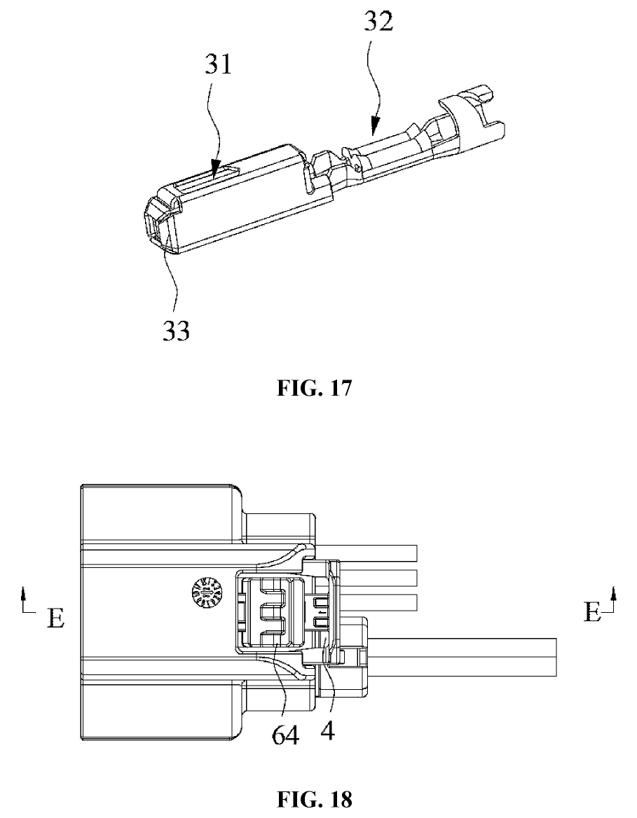

Referring to FIG. 8 and FIG. 17, the outer wall surface of the second terminal 3 is provided with a second recess 31, and the second fastener 14 includes a second elastic arm 141 and a second locking block 142 that are integrally formed. The end of the second elastic arm 141 facing the third hole opening 121 is connected to the hole wall of the second mounting hole 12. The other end of the second elastic arm 141 is gradually away from the hole wall of the second mounting hole 12 in the direction toward the fourth hole opening 122. The second locking block 142 is disposed on the side of the second elastic arm 141 facing away from the hole wall of the second mounting hole 12. Specifically, the second recess 31 is a groove formed on the outer wall surface of the second terminal 3.

The second terminal 3 can press the second fastener 14 after being inserted into the second mounting hole 12 from the third hole opening 121. The second elastic arm 141 deforms to drive the second locking block 142 to move toward the hole wall of the second mounting hole 12 until the second locking block 142 is locked into the second recess 31. At this time, the third stop surface 161 abuts against the third abutting surface 33, and the second terminal 3 is locked under the cooperation of the second fastener 14.

In this embodiment, the side of the second locking block 142 facing the third hole opening 121 is also provided with a second guide surface. The second guide surface gradually inclines from the side of the second guide surface facing the third hole opening 121 to the central direction of the second mounting hole 12 to reduce the difficulty of crossing the second locking block 142 when the end of the second terminal 3 inserted into the second mounting hole 12 moves toward the fourth hole opening 122.

It is to be understood that the position of the second recess 31 and the position of the second locking block 142 can be interchanged between the second elastic arm 141 and the second terminal 3.

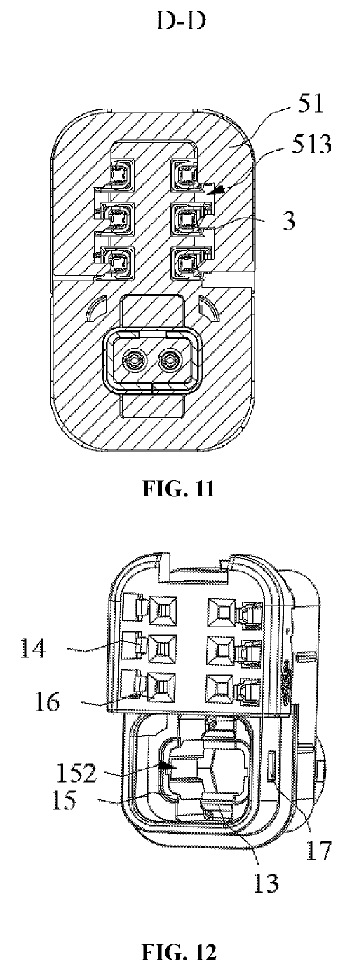

The second locking member 5 is inserted, along the reverse direction of the third direction, into the insulating body 1 from the side facing away from the first terminal 2. Referring to FIG. 10, FIG. 11, and FIG. 16, an relief groove 513 penetrates the second locking member 5 along the first direction. The relief groove 513 on the second locking member 5 at the pre-installation position faces the second terminal 3 to allow the second terminal 3 to be inserted into or separated from the second mounting hole 12. The relief groove 513 on the second locking member 5 at the final locking position avoids the second terminal 3 locked in the second mounting hole 12.

To avoid the second locking member 5 when the second locking member 5 moves in the third direction, the second terminal 3 is provided with an avoidance groove 32. Based on the premise that the second terminals 3 are disposed in rows along the third direction, the avoidance grooves 32 on the second terminals 3 are arranged along the third direction, and the number of relief grooves 513 on the second locking member 5 is the same as the number of second terminals 3.

In an example in which two rows of second terminals 3 are provided symmetrically spaced apart along the second direction, with continued reference to FIG. 16, the second locking member 5 includes a connecting portion 52 and two cantilever portions 51. The connecting portion 52 extends along the second direction. The two cantilever portions 51 are disposed on two sides of the connecting portion 52 that are opposite along the second direction, and the two cantilever portions 51 are perpendicular to the connecting portion 52 so that the second locking member 5 is approximately U-shaped. The relief grooves 513 are disposed on the cantilever portion 51. When the cantilever portion 51 is inserted into the insulating body 1 until the second terminals 3 are in the pre-installation position, the relief grooves 513 on the cantilever portion 51 are in one-to-one correspondence with the second terminals 3, not affecting the insertion of the second terminals 3 into the second mounting holes 12 or the disengagement of the second terminals 3 from the second mounting holes 12. As the cantilever portion 51 continues being inserted into the insulating body 1 until the second terminals 3 reach the final locking position, the relief grooves 513 avoid the second terminals 3, preventing the second terminals 3 from moving toward the fourth opening 122.

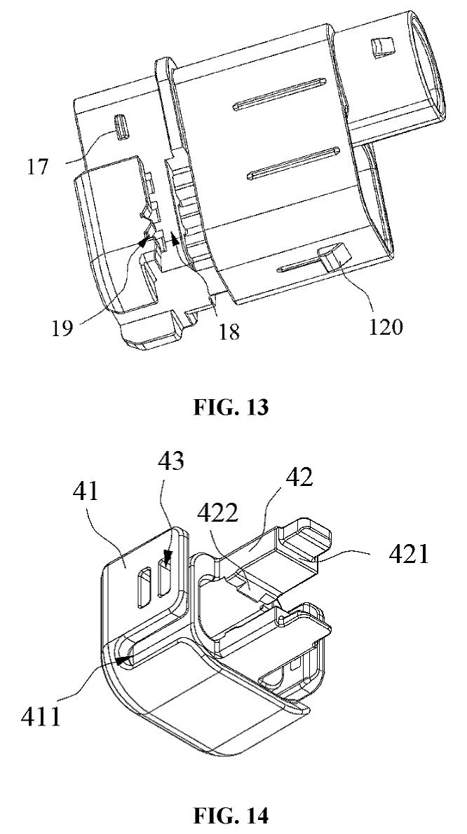

Referring to FIG. 13, to guide the second terminals 3 when the second terminals 3 are inserted into the insulating body 1, the outer wall of the insulating body 1 is provided with two fixing grooves 18 extending in the third direction. Each of the two fixing grooves 18 communicates with a respective row of the two rows of second mounting holes 12. Each of the two cantilever portions 51 is inserted into the insulating body 1 along a respective one of the two fixing grooves 18.

Further, to facilitate the observation of whether the second locking member 5 is at the pre-installation position or the final locking position and improve the stability of the second locking member 5 assembled on the insulating body 1, a second positioning block 514 is also disposed on one of the second locking member 5 or the insulating body 1, and a second slot hole 19 snap-fitted to the second positioning block 514 is formed the other of the second locking member 5 or the insulating body 1. Two second slot holes 19 are provided and spaced apart in the third direction. When the second positioning block 514 is limited in one of the two second slot holes 19 far from the second hole opening 2, the second locking member 5 is at the pre-installation position. When the second positioning block 514 is limited in one of the two second slot holes 19 adjacent to the second hole opening 2, the second locking member 5 is at the final locking position.

Illustratively, the second positioning block 514 is disposed on the cantilever portion 51 of the second locking member 5. On each of the two cantilever portions 51, there is a second positioning block 514. The second slot holes 19 corresponding to the second positioning blocks 514 are formed on the slot side walls of the two fixing slots 18.

To reduce the difficulty of the second positioning block 514 entering the second slot hole 19, the second positioning block 514 is designed to be triangular. Moreover, the second locking member 5 is also provided with a strip-shaped avoidance hole 515 extending in the third direction. When the second positioning block 514 enters the second slot hole 19, the avoidance hole 515 provides an avoidance space for the deformation of the second locking member 5. Specifically, the cantilever portion 51 also includes a mounting portion 512 and a locking portion 511 that are in an L shape. The mounting portion 512 and the locking portion 511 are both connected to the connecting portion 52. The mounting portion 512 can slide in the fixing groove 18. The locking portion 511 is inserted into the second mounting hole 12. The second positioning block 514 and the relief groove 513 are disposed on the mounting portion 512 and the locking portion 511 respectively. The mounting portion 512 is provided with a strip-shaped avoidance hole 515 extending in the third direction to enhance the plasticity of the second locking member 5, reduce the difficulty of switching the second locking member 5 between the pre-installation position and the final locking position, and reduce the material cost of manufacturing the second locking member 5.

More specifically, to reduce the difficulty of disassembling the second locking member 5, the connecting portion 52 is also provided with a force applying groove 521 for facilitating force application. The force applying groove 521 extends to the surface of the connecting portion 52 in the reverse direction of the first direction.

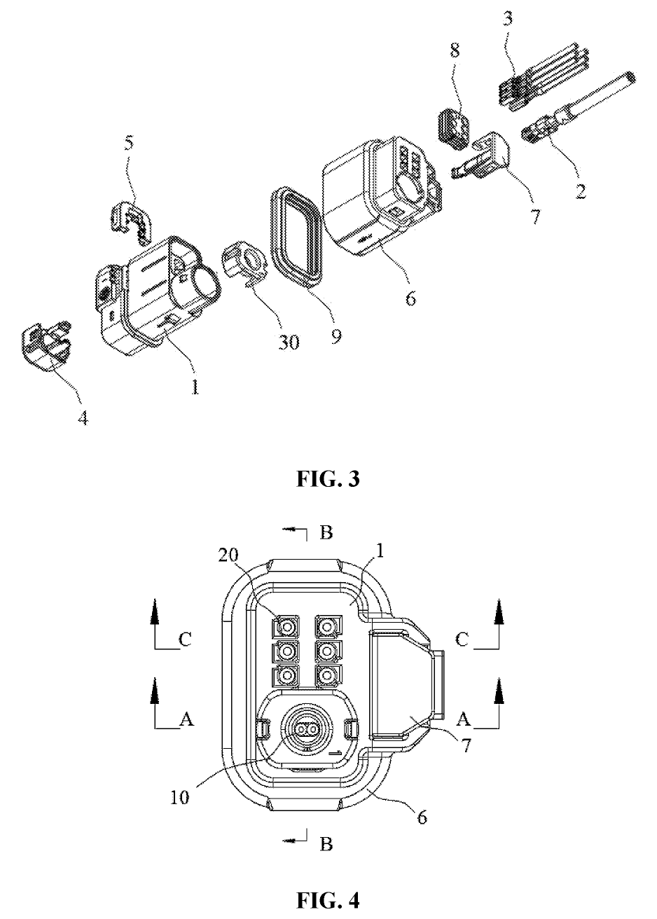

Referring to FIG. 3 and FIG. 8, the connector also includes a first sealing ring 8. The first sealing ring 8 is disposed at the fourth hole opening 122 of the second mounting hole 12 and is provided with a through hole 84 for the second cable 20 to pass through. The first sealing ring 8 can block a gap between the fourth hole opening 122 and the second terminal 3, achieving dustproof and waterproof effects.

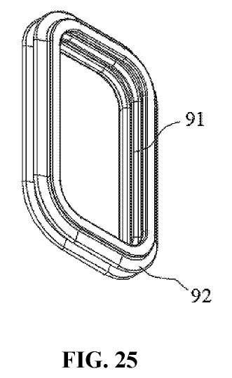

Referring to FIG. 24, on the premise that multiple second terminals 3 are provided, the first sealing ring 8 is a group sealing ring. The group sealing ring is provided with multiple through holes 84 in one-to-one correspondence with the multiple second mounting holes 12. Specifically, the insulating body 1 is provided with a mounting groove 110 communicating with each second mounting hole 12. The first sealing ring 8 is mounted in the mounting groove 110. To improve the sealing performance of the first sealing ring 8, the first sealing ring 8 includes a sealing body 83 and multiple first annular protrusions 81 disposed on the outer wall surface of the sealing body 83 and spaced apart in the first direction. The first annular protrusions 81 are annular to increase the contact area with the side wall of the mounting groove 110 and improve the sealing performance. Moreover, on the hole wall of each through hole 84, second annular protrusions 82 are spaced apart in the first direction. The second annular protrusions 82 are also annular to increase the contact area with the second cable 20 and improve the sealing performance.

Referring to FIG. 1 to FIG. 3, the connector also includes a housing 6. The housing 6 has a cavity opened on one side of the cavity and opened in the first direction. The insulating body 1 is located in the cavity of the housing 6. The housing 6 is configured to protect the insulating body 1. An operation hole 61 communicating with the cavity of the housing 6 is formed at a position of the housing 6 corresponding to the connecting portion 52 of the second locking member 5. A force in the direction of the first terminal 2 can be applied to the second locking member 5 through the operation hole 61 so that the second locking member 5 can be switched from the pre-installation position to the final locking position.

It is to be noted that the length of the operation hole 61 in the second direction is less than the length of the connecting portion 52 in the second direction, that is, the orthographically projected area of the second locking member 5 in the direction of the operation hole 61 is greater than the area of the operation hole 61, thereby preventing the second locking member 5 from being separated from the insulating body 1 from the operation hole 61 during transportation or from being squeezed to the final locking position during transportation.

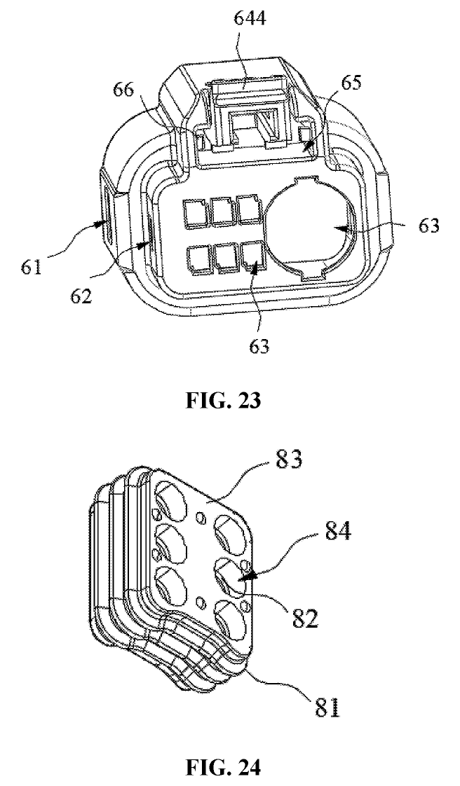

Specifically, referring to FIG. 22 and FIG. 23, the housing 6 is provided with a third slot hole 62, and the insulating body 1 is provided with a third positioning block 120 snap-fitted to the third slot hole 62. The third positioning block 120 is limited in the third slot hole 62, thereby achieving a detachable and fixed connection between the insulating body 1 and the housing 6. More specifically, two third slot holes 62 are symmetrically disposed on the housing 6 along the third direction, and two third positioning blocks 120 are provided to improve the stability of the connection between the housing 6 and the insulating body 1. Moreover, an inclined third guide surface is formed at the end of the third positioning block 120 facing away from the slot opening of the housing 6 to reduce the difficulty of clamping the third positioning block 120 into the third slot hole 62. Of course, the third slot hole 62 may also be disposed on the insulating body 1, and the third positioning block 120 may also be disposed on the housing 6.

Referring to FIG. 16, the first hole opening 111 and the third hole opening 121 on the insulating body 1 both face the closed end of the housing 6, and the closed end of the housing 6 is provided with multiple exit holes 63 formed at positions corresponding to the first mounting hole 11 and the second mounting hole 12 and configured for the first cable 10 and the second cable 20 to pass through.

A gap is formed between the housing 6 and the end of the insulating body 1 facing the opening of the housing 6 and configured for the mating connector to be inserted into. To lock the mating connector to the connector, the housing 6 also includes a third fastener 64 disposed on the inner wall of the housing 6. The third fastener 64 is snap-fitted to the connector.

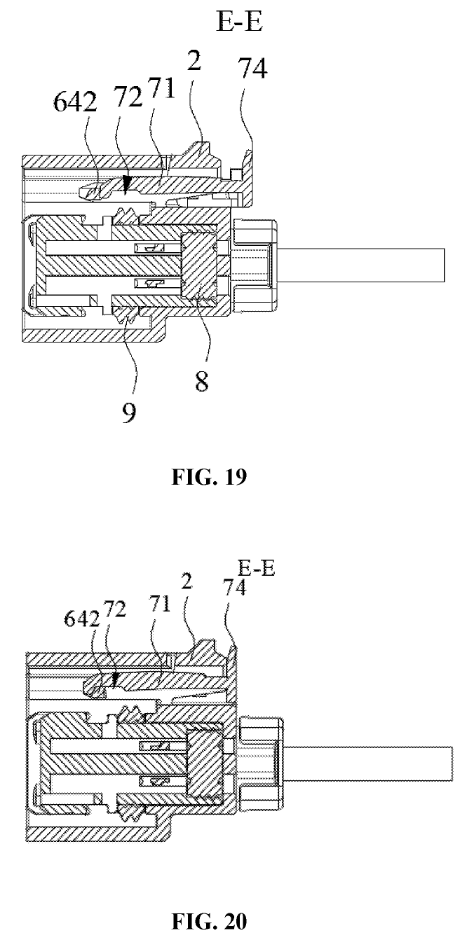

Specifically, referring to FIG. 19 and FIG. 22, the third fastener 64 includes a third elastic arm 641 and a third recess 643. The third elastic arm 641 is connected to the inner wall of the housing 6. The third recess 643 is disposed at the end of the third elastic arm 641 extending toward the slot opening. A third locking block fitting the third recess 643 is formed on the mating connector. The third locking block can be locked into the third recess 643 to lock the mating connector.

More specifically, two third elastic arms 641 are provided and spaced apart along the third direction. The two third elastic arms 641 are connected by a connecting rod 642 so that the third recess 643 is formed between the two third elastic arms 641, and the third locking block is locked into the third recess 643 and abuts against the connecting rod 642.

Referring to FIG. 19 and FIG. 23, the closed end of the housing 6 is formed with an insertion hole 65 for the third fastener 64 to extend into the cavity of the housing 6. The insertion hole 65 communicates with the cavity of the housing 6. The third elastic arm 641 is connected to the hole wall of the insertion hole 65 through a fulcrum. The end of the third elastic arm 641 connected to the connecting rod 642 extends into the cavity of the housing 6 from the insertion hole 65. The other end of the third elastic arm 641 is located outside the housing 6. To unlock the third fastener 64 from the mating connector, it is only necessary to press the end of the third elastic arm 641 located outside the housing 6.

To better improve the stability between the connector and the mating connector, the connector also includes a third locking member 7. The third locking member 7 also has a pre-installation position and a final locking position. The third locking member 7 in the pre-installation position allows the mating connector to be inserted into the preset position in the housing 6. The third locking member 7 in the final locking position makes the third fastener 64 keep locking the mating connector.

With continued reference to FIG. 19 and FIG. 20, the third locking member 7 is inserted into the housing 6 along the first direction from the closed end of the housing 6, and the third locking member 7 includes a locking arm 71. The locking arm 71 of the third locking member 7 in the pre-installation position is located on the side of the connecting rod 642 facing away from the opening of the housing 6. The locking arm 71 of the third locking member 7 in the final locking position abuts against the outer side of the third fastener 64 to prevent the third fastener 64 from moving away from the third locking block. Specifically, the locking arm 71 is provided with a locking groove 72. The connecting rod 642 can be locked in the locking groove 72 and abut against the bottom of the locking groove 72.

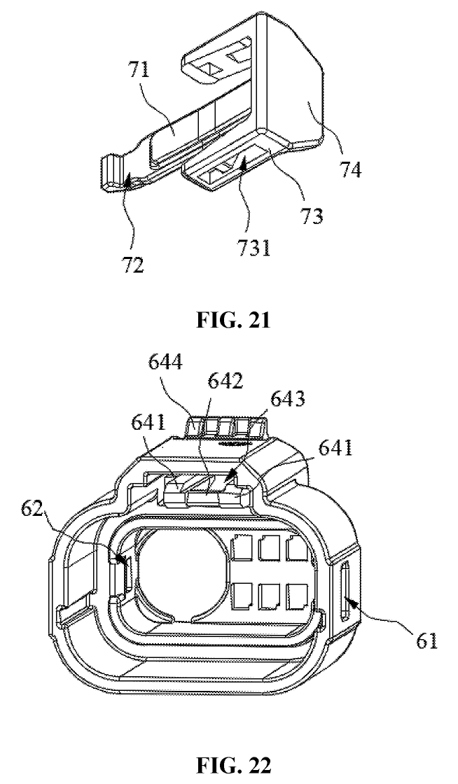

Referring to FIG. 21 and FIG. 23, to improve the stability of the third locking member 7 assembled on the housing 6, a fourth positioning block 66 is also disposed on one of the third locking member 7 or the housing 6, and a fourth slot hole 731 snap-fitted to the fourth positioning block 66 is formed the other of the third locking member 7 or the housing 6. Two fourth slot holes 731 are provided and spaced apart in the first direction. When the fourth positioning block 66 is limited in one of the two fourth slot holes 731 far from the opening of the housing 6, the fourth locking member is at the pre-installation position. When the fourth positioning block 66 is limited in one of the two fourth slot holes 731 adjacent to the opening of the housing 6, the fourth locking member is at the final locking position.

Illustratively, the third slot hole 62 is formed on the third locking member 7, and the third positioning block 120 is disposed on the housing 6, specifically on the hole wall of the insertion hole 65. Specifically, the third locking member 7 includes two positioning arms 73 disposed at two opposite sides of the locking arm 71 and spaced apart along the third direction. The two positioning arms 73 are both connected to the locking arm 71 and inserted into the insertion hole 65. The third slot hole 62 is formed on the positioning arm 73. Moreover, to reduce the difficulty of disassembly and assembly of the third locking member 7, the third locking member 7 also includes a sliding plate 74. The sliding plate 74 connects the locking arm 71 and the end of the positioning arm 73 located outside the housing 6.

With continued reference to FIG. 23, to facilitate applying a force to the third fastener 64 to disengage the mating connector from the connector, for each third elastic arm 641, the end of the elastic arm 641 facing away from the connecting rod 642, that is, the end of the third elastic arm 641 located outside the housing 6, is connected to a U-shaped connecting block 644, and the elastic arm 641 is connected to two ends of the connecting block 644. The force applied to the connecting block 644 makes the third elastic arm 641 move away from the third locking block under the action of a lever so that the third elastic arm 641 is separated from the third locking block. The locking arm 71 of the third locking member 7 extends through the connecting block 644 and is inserted into the housing 6. The unlocking of the third locking member 7 and the unlocking of the third fastener 64 do not interfere with each other.

Referring to FIG. 3 and FIG. 19, the connector also includes a second sealing ring 9. The second sealing ring 9 is sleeved on the insulating body 1 and is located in the gap formed between the insulating body 1 and the housing 6. The second sealing ring 9 can abut against the mating connector inserted into the housing 6 to achieve sealing between the mating connector and the insulating body 1, thereby better improving waterproof and dustproof performance of the connector assembly.

Specifically, multiple third annular protrusions 91 and multiple fourth annular protrusions 92 are disposed on the inner peripheral wall and the outer peripheral wall of the second sealing ring 9 respectively. The third annular protrusions 91 are spaced apart along the first direction. The fourth annular protrusions 92 are spaced apart along the first direction. This increases the contact area between the second sealing ring 9 and the insulating body 1 and the mating connector, thereby improving the sealing performance.

When the connector is assembled, the injection-molded second locking member 5 is inserted into the insulating body 1 along the third direction so that the second locking member 5 is in the pre-installation position; the second sealing ring 9 is sleeved on the insulating body 1; the injection-molded first locking member 4 is inserted into the first mounting hole 11 along the first direction so that the first locking member 4 is in the pre-installation position; the first sealing ring 8 is mounted in the mounting groove 110; the housing 6 is sleeved on the insulating body 1; the third locking member 7 is inserted into the housing 6; and then the first terminal 2 and the second terminal 3 are inserted; and the first locking member 4 and the second locking member 5 are pushed to the final locking position when required.

When the first terminal 2 is required to be removed from the first mounting hole 11 so that a new first terminal 2 can be mounted, the first locking member 4 is removed from the insulating body 1 through a tool and then inserted into the first mounting hole 11 through the tool, and then the first fastener 13 is pried toward the hole wall of the first mounting hole 11 through the tool so that the first terminal 2 is separated from the insulating body 1, thereby effectively reducing fault maintenance costs. When the second terminal 3 is required to be removed from the second mounting hole 12 so that a new second terminal 3 can be mounted, a force away from the insulating body 1 in the third direction may be applied to the second locking member 5 through the force applying groove 521 so that the second locking member 5 is removed from the insulating body 1; and then a force away from the second terminal 3 is applied to the second fastener 14 through the tool entering the second mounting hole 12 so that the second fastener 14 is separated from the second terminal 3 so that the second terminal 3 is separated from the insulating body 1. When the mating connector and the connector are required to be separated, a pressure is applied to the sliding plate 74 of the third locking member 7 so that the end of the third locking member 7 snap-fitted to the third fastener 64 is separated from the third fastener 64, and then the third locking member 7 is withdrawn out of the housing 6; and then a pressure is applied to the connecting block 644 of the third fastener 64 so that the end of the third fastener 64 snap-fitted to the mating connector is separated from the mating connector so that the mating connector is withdrawn out of the housing 6.

Apparently, the preceding embodiments of this invention are only illustrative examples of this invention and are not intended to limit embodiments of this invention. Those of ordinary skill in the art can make various apparent modifications, adaptations, and substitutions without departing from the scope of this invention. All embodiments do not need to be and cannot be exhausted herein. Any modifications, equivalent substitutions, and improvements made within the spirit and principle of this invention fall within the scope of the claims of this invention.

What is claimed is:

1. A connector, comprising:
an insulating body provided with a first mounting hole, wherein a first fastener is disposed in the first mounting hole;
a first terminal inserted into the first mounting hole and snap-fitted to the first fastener; and
a first locking member detachably inserted into the insulating body and configured to allow the first terminal to be inserted into the first mounting hole when the first locking member is at a pre-installation position of the first locking member and limit a position of the first fastener when the first locking member is at a final locking position of the first locking member.

2. The connector of claim 1, wherein the first locking member is inserted into the insulating body along a length direction of the first mounting hole.

3. The connector of claim 2, wherein the first locking member comprises a sleeve portion and an insertion portion, the sleeve portion is connected to the insertion portion and located outside the insertion portion, the sleeve portion is sleeved around the insulating body, and an inner side of the insertion portion abuts against a side of the first fastener facing away from the first terminal when the first locking member is at the final locking position.

4. The connector of claim 1, wherein a first positioning block is disposed on one of the first locking member or the insulating body, a first slot hole snap-fitted to the first positioning block is formed on the other of the first locking member or the insulating body, two first slot holes are provided, and the first positioning block is snap-fitted to one of the two first slot holes when the first positioning block is at the pre-installation position of the first locking member and is snap-fitted to the other of the two first slot holes when the first positioning block is at the final locking position of the first locking member.

5. The connector of claim 1, further comprising a second terminal, wherein the insulating body is provided with a second mounting hole, and the second terminal is inserted into the second mounting hole.

6. The connector of claim 5, further comprising a first sealing ring secured to one side of the insulating body and abutting against the insulating body, wherein a plurality of second terminals are provided, a plurality of second mounting holes are provided, the plurality of second terminals are in one-to-one correspondence with the plurality of second mounting holes, and each of the plurality of second terminals is connected to a second cable that passes through the first sealing ring.

7. The connector of claim 5, wherein the first terminal is a low-voltage terminal, and the second terminal is a terminal for transmitting an Ethernet signal.

8. The connector of claim 1, further comprising a second sealing ring sleeved around the insulating body and configured to abut against a mating connector sleeved around the insulating body.

9. The connector of claim 1, further comprising a housing fixedly sleeved around the insulating body.

10. The connector of claim 9, wherein a gap for the mating connector to be inserted into is formed between the housing and the insulating body, and the connector further comprises a third locking member inserted into the housing and configured to lock the mating connector.

11. The connector of claim 2, further comprising a second terminal, wherein the insulating body is provided with a second mounting hole, and the second terminal is inserted into the second mounting hole.

12. The connector of claim 3, further comprising a second terminal, wherein the insulating body is provided with a second mounting hole, and the second terminal is inserted into the second mounting hole.

13. The connector of claim 4, further comprising a second terminal, wherein the insulating body is provided with a second mounting hole, and the second terminal is inserted into the second mounting hole.

14. The connector of claim 2, further comprising a second sealing ring sleeved around the insulating body and configured to abut against a mating connector sleeved around the insulating body.

15. The connector of claim 3, further comprising a second sealing ring sleeved around the insulating body and configured to abut against a mating connector sleeved around the insulating body.

16. The connector of claim 4, further comprising a second sealing ring sleeved around the insulating body and configured to abut against a mating connector sleeved around the insulating body.

17. The connector of claim 2, further comprising a housing fixedly sleeved around the insulating body.

18. The connector of claim 3, further comprising a housing fixedly sleeved around the insulating body.

19. The connector of claim 4, further comprising a housing fixedly sleeved around the insulating body.

20. A connector assembly, comprising a connector and a mating connector for mating with the connector,
wherein the connector comprises:
an insulating body provided with a first mounting hole, wherein a first fastener is disposed in the first mounting hole;
a first terminal inserted into the first mounting hole and snap-fitted to the first fastener; and
a first locking member detachably inserted into the insulating body and configured to allow the first terminal to be inserted into the first mounting hole when the first locking member is at a pre-installation position of the first locking member and limit a position of the first fastener when the first locking member is at a final locking position of the first locking member.
